(19) United States
(12) Patent Application Publication
(10) Pub. No.: US 2022/0337434 A1
(43) Pub. Date: Oct. 20, 2022

(54) SECURE SUPPLY CHAIN AND PROVISIONING OF DEVICES AND METHODS

(71) Applicant: Noodle Technology Inc., San Francisco, CA (US)

(72) Inventors: Garrett Edward Kinsman, San Francisco, CA (US); Lucien Jean Baptiste Loiseau, San Francisco, CA (US); Eliott Quentin Eric Teissonniere, San Francisco, CA (US); Micha Anthenor Benoliel, San Francisco, CA (US)

(21) Appl. No.: 17/659,480

(22) Filed: Apr. 15, 2022

Related U.S. Application Data
(60) Provisional application No. 63/176,195, filed on Apr. 16, 2021.

(51) Int. Cl. H04L 9/32

(52) U.S. Cl. CPC H04L 9/3268; H04L 9/3247

(57) ABSTRACT

Disclosed are adaptable, auditable, and seamless provisioning systems, methods and processes that allow easy deployment and provisioning of devices and device components through a device manufacturing process and end user deployment. The systems and methods create a cryptographic proof that devices and associated components are authentic, securely set-up, and operated throughout the lifetime of the device. Methods and systems are provided to securely provision devices and components throughout a supply chain and deploy into an environment.

### CROSS-REFERENCE

This application claims the benefit of U.S. Provisional Application No. 63/176,195, filed Apr. 16, 2022, entitled Secure Supply Chain and Provisioning of Devices which application is incorporated herein in its entirety by reference.

### BACKGROUND

### Field

The disclosure relates to provisioning of devices in a secure supply chain.

### Background

Deploying, connecting and provisioning credentials and certificates for a large number of connected devices is difficult. Even when the devices are provisioned the devices may not be provisioned securely. What is needed are devices and methods that enable deploying, connecting, and provisioning credentials and certificates for a large number of connected devices beginning at the component manufacturing process through device manufacturing and end user deployment.

### SUMMARY

Disclosed is an adaptable, auditable, and seamless provisioning process that allows easy deployment and provisioning of devices and components from component manufacturing process through device manufacturing and end user deployment. The systems and methods are operable to create a cryptographic proof that devices and associated components are authentic, securely set-up, and operated throughout the lifetime of the device. Methods and systems are provided to securely provision devices and components throughout a supply chain and deploy into an environment. Devices and components may include a message, a beacon, an IoT device, a sensor, wireless infrastructure, base stations, cell towers, SIM cards avionics, components and subcomponents of an assembly, pick and PCB components.

Disclosed are methods to coordinate the certificates (using a centralized or decentralized certificate authority) across components in a supply chain, sub-assemblies factory assemblies, non-provisioned devices, provisioned devices, and the number of other certificates that may be required for the normal operation of the device.

The disclosed methods also include provisioning, or cryptographically attaching the device to credentials, a network, management system, a serial number, a location, a customer, a customer configuration, and associate other metadata to the device. The disclosed methods also include a method for transferring ownership of the devices processed under the disclosed methods.

Methods are disclosed for connecting to the manufactured devices in a peer-to-peer fashion to load provisioning information (e.g., certificates, serial numbers, owners, identifying information, eSIM credentials, network settings, radio settings, location, and other metadata). A decentralized or centralized network can be used which is separate from the provisioning device to load provisioning information into the device. A mobile app or AR app that uses camera and computer vision to identify the marks and the device or part to authenticate or configure. Visual identifiers such as iChing code, glitter, QR code, datamatrix, text, other markings, can be used with computer vision without a visual identifier. The methods including using one “group ID” or Box ID” to provision many serial numbers associated with devices and/or device components. The “Box ID” can represent a long serial number. Hashing can also be used to obfuscate actual serial numbers (instead of sequential serials). Additionally, multiple certificates can be used across several components entities, systems, and root authorities to verify the supply chain and integrity of the device during manufacturing, provisioning, and across the device lifecycle.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

U.S. Pat. No. 10,839,411 B2 issued Nov. 17, 2020, to Benoliel et al.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates example network architecture;

FIGS. 2A-B illustrates a provisioning process sequence diagram 200 of from supplier to verifier;

FIG. 3 illustrates a sequence diagram of a verification process;

FIG. 4 illustrates a flow diagram of a provisioning process after factory;

FIG. 5A illustrates a group ID and box ID;

FIG. 5B illustrates a QR code and easy ID;

FIG. 5C illustrates a QR code;

FIG. 6 illustrates a flow diagram of factory provisioning process;

FIG. 7 illustrates a sequence diagram of a factory production process; and

FIGS. 8A-B illustrates example box labels.

### DETAILED DESCRIPTION

I. Network Architecture

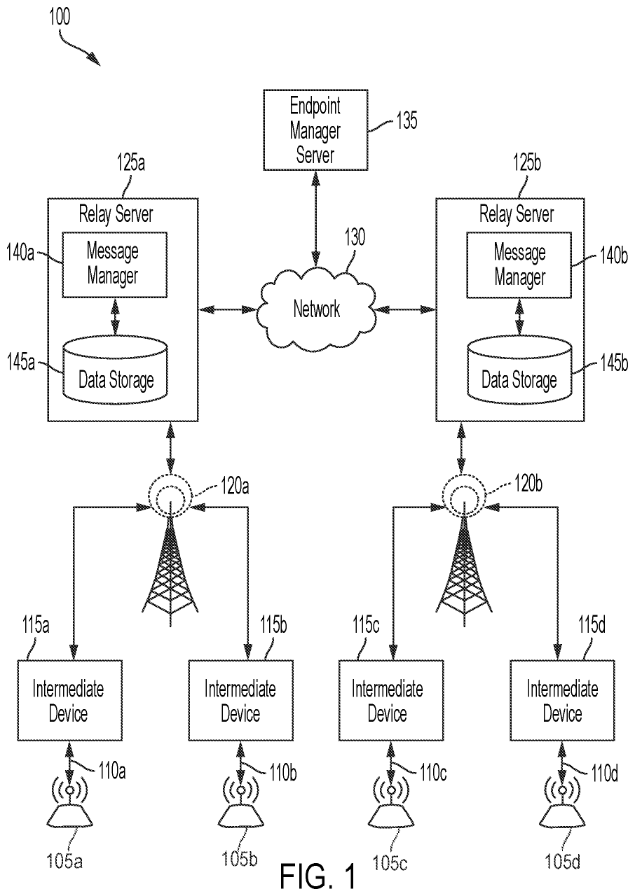

FIG. 1 illustrates an example network architecture 100 in which embodiments of the present disclosure may be implemented for various provisioning processes, as described herein. The provisioning process can be for any device, including large and small devices, stickers, printed devices, and the like. The network architecture 100 may include one or more endpoint devices 105, one or more intermediate devices 115, one or more relay servers 125, and one or more endpoint manager servers 135. In some embodiments, the network architecture 100 may be capable to move data between one or more endpoint devices 105 and various endpoint manager servers 135 by way of crowd-sourced intermediate devices 115, which may function act as network clients, and one or more relay servers 125. The network architecture 100 may include or provide a decentralized network.

An endpoint device 105 may include one or more IoT devices. The endpoint device 105 may also include a power supply, a data collection device (e.g., a sensor), provisioning logic, and a network device. The power supply may include a battery or a connection to a power grid. Additionally or alternatively, the power supply may include an energy harvesting apparatus, such as a solar panel, solar cell, solar photovoltaic, electromagnetic, etc. In at least some embodiments, the endpoint device 105 may not include a power supply and may instead use ambient backscatter techniques. The endpoint device 105 may also include one or more sensors. The one or more sensors may be configured to detect any type of condition, and generate electronic data based on a detected condition. For example, the endpoint device 105 may include a smart watch with a heart rate monitor that is configured to generate heart rate data using heart rate conditions collected by the heart rate monitor. In at least one embodiment, the endpoint device 105 does not have capability to communicate over the Internet and only includes hardware and/or software capable of communicating with nearby devices, such as a nearby intermediate device 115. The endpoint device 105 may include any device that may be manufactured, at least partially, using a printing process or step. The endpoint device 105 may include a compute device with an antenna combination that includes at least one primary antenna element operably coupled to at least one other electronic component that services as a ground plane for the at least one primary antenna element.

The network device of the endpoint device 105 may include any hardware, software, or combination thereof that is capable to communicate with another device via a network. In at least one embodiment, the network device may include any network controller configured to communicate via a short-range network, such as Bluetooth® or any other short-range network. In at least one embodiment, the network device may include any network controller configured to communicate via a low-power network. Example endpoint devices 105 include, but are not limited to, industrial devices, residential appliances, commercial equipment, inventory trackers, smart watches, wearables, heart rate monitors, logistics trackers, environmental sensors, cash registers, credit card readers, point-of-sale (POS), vehicles, bikes, electric scooters, electric skate boards, cars, electric cars, satellites, or any device (mobile and not mobile that includes a wireless radio interface. The network architecture 100 may include any number of endpoint devices 105 and the endpoint devices 105 in the network architecture 100 may be any type of endpoint device 105, including any type of network-capable device. The endpoint devices 105 may be fixed or relatively stationary in the network architecture 100

The one or more endpoint devices 105 may be configured to communicate with other devices via at least one wireless network 110. For example, a first endpoint device 105a may be in electronic communication with a first intermediate device 115a via a first short-range wireless network 110a. The one or more intermediate devices 115 may include any type of device capable of communicating with an endpoint device 105 via the wireless network 110 and with a relay server 125 via a second network 120. In at least one embodiment, an intermediate device 115 may include two network controllers—a first network controller to communicate via the wireless network 110 and a second network controller to communicate via the second network 120. Example intermediate devices 115 include personal computers (PC), laptops, smart phones, netbooks, e-readers, personal digital assistants (PDA), cellular phones, mobile phones, tablets, any endpoint device 105, etc.

As illustrated, the first endpoint device 105a may be in electronic communication with the first intermediate device 115a via the first short-range wireless network 110a (e.g., a short-range network). Further, a second endpoint device 105b may be in electronic communication with a second intermediate device 115b via a second short-range wireless network 110b (e.g., a low-power network). A third endpoint device 105c may be in electronic communication with a third intermediate device 115c via another wireless network 110c. A fourth endpoint device 105d may be in electronic communication with a fourth intermediate device 115d via another wireless network 110d.

As will be appreciated by those skilled in the art, the systems can use a variety of technology. In some embodiments, the wireless network 110 may be any network that uses a relatively low amount of power. Example wireless networks 110 may include any Bluetooth network type (e.g., Bluetooth Low Energy (BLE), Bluetooth 4.0, Bluetooth 5.0, Bluetooth Long Range), NB-IoT, LTE Direct, LTE-M, LTE M2M, 5G, Wi-Fi™, Wi-Fi Aware or any low-power network. Category M1, or Cat M1 wireless (LTE-M), is a low power wide area network cellular technology designed for IoT projects with an average upload speed between 200 kbps and 400 kbps are also contemplated. The Wi-Fi networks include an internet connection that is shared with multiple devices in and via a router.

The one or more endpoint devices 105 may connect to various intermediate devices 115 using different types of wireless networks 110. For example, the first endpoint device 105a may be in electronic communication with the first intermediate device 115a via a first short-range wireless network 110a and the second endpoint device 105b may be in electronic communication with the second intermediate device 115b via a second short-range wireless network 110b.

Endpoint devices 105, intermediate devices 115, or both, may be fixed, relatively stationary or moveable. When an endpoint device 105 and an intermediate device 115 come into wireless range of each other, the endpoint device 105 and the intermediate device 115 may perform a handshake and/or authentication to initiate data exchange between the endpoint device 105 and the intermediate device 115.

In some embodiments, the endpoint device 105 may periodically send messages (e.g., beacons) that include data via the wireless network 110. The endpoint devices 105 may include various services that may run on the endpoint devices 105. Messages may be generated for each of these services or a single message may be generated to include data for some or all of the services. For example, the message may include an indication that the endpoint device 105 is available to be provisioned.

An intermediate device 115 may listen for such messages from endpoint devices 105. Responsive to receiving a message (e.g., beacon), the intermediate device 115 may send the message to a relay server 125 via a second network 120. In at least one embodiment, the wireless network 110 and the second network 120 are different types of networks. For example, the wireless network 110 may be a Bluetooth network and the second network 120 may be a cellular network, Wi-Fi, or the Internet.

The second network 120 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), routers, hubs, switches, server computers, and/or a combination thereof.

Additionally or alternatively, the intermediate device 115 may include provisioning logic that may use the message from the endpoint device 105 to provision the endpoint device 105. For example, the intermediate device 115 may have received information and/or instructions for provisioning various devices and may use that information and/or instructions to provision the endpoint device 105.

The relay server 125 may send the message, or information related to the message, to an endpoint manager server 135 via a third network 130. The third network 130 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), routers, hubs, switches, server computers, and/or a combination thereof. In at least one embodiment, the second network 120 and the third network 130 are the same network or include at least some overlapping components.

The one or more relay servers 125 may include one or more computing devices, such as a rackmount server, a router computer, a server computer, a personal computer, a mainframe computer, a laptop computer, a tablet computer, a desktop computer, smartphone, cars, drones, a robot, any mobility device that has an operating system, etc.), data stores (e.g., hard disks, memories, databases), networks, software components, and/or hardware components. The one or more relay servers 125 may be configured to receive a message from an intermediate device 115 and the message may include provisioning information, such as a notification that the endpoint device 105 is available for provisioning or has requested to be provisioned. The one or more relay servers 125 may send the message, or data related to or associated with to an endpoint manager server 135. The one or more relay servers 125 may receive the message from the endpoint manager server 135 and, in some embodiments, may send the message from the endpoint manager server 135 to an intermediate device 115. In at least some embodiments, the intermediate device 115 may perform one or more operations responsive to receiving the message from the endpoint manager server 135, such as initiating provisioning for the endpoint device 105. The operations include operations local to the intermediate device 115, and/or sending the message from the endpoint manager server 135 to an endpoint device 105.

The endpoint manager server 135 may include one or more computing devices, such as a rackmount server, a router computer, a server computer, a personal computer, a mainframe computer, a laptop computer, a tablet computer, a desktop computer, a smartphone, a car, a drone, a robot, any mobility device that has an operating system etc.), data stores (e.g., hard disks, memories, databases), networks, software components, and/or hardware components. The endpoint manager server 135 may be associated with one or more endpoint devices 105. For example, a particular corporation, person, or manufacturer may sell an endpoint device 105 and may use an endpoint manager server 135 to communicate with and/or control the endpoint device 105.

The endpoint manager server 135 may send messages or information associated with a particular endpoint device 105, or a set of endpoint devices 105. For example, the endpoint manager server 135 may send provisioning information, updates (e.g., firmware, software) to the particular endpoint device 105, or the set of endpoint devices 105. The endpoint manager server 135 may send other communications to an endpoint device 105, such as a response to a provisioning request from a message generated by the particular endpoint device 105.

Each relay server 125 may include a message manager 140. The message manager 140 may be implemented using hardware including a processor, a microprocessor (e.g., to perform or control performance of one or more operations), an FPGA, or an ASIC. In some other instances, the message manager 140 may be implemented using a combination of hardware and software. Implementation in software may include rapid activation and deactivation of one or more transistors or transistor elements such as may be included in hardware of a computing system (e.g., the relay server, or endpoint manager server 135). Additionally, software defined instructions may operate on information within transistor elements. Implementation of software instructions may at least temporarily reconfigure electronic pathways and transform computing hardware.

Each relay server 125 may include a data storage 145. The data storage 145 may include any memory or data storage. In some embodiments, the data storage 145 may include computer-readable storage media for carrying or having computer-executable instructions or data structures stored thereon. The computer-readable storage media may include any available media that may be accessed by a general-purpose or special-purpose computer, such as a processor. For example, the data storage 145 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 145. In the depicted embodiment, the data storage 145 is part of the relay server 125. In some embodiments, the data storage 145 may be separate from the relay server 125 and may access the data storage 145 via a network. In at least one embodiment, the data storage 145 may include multiple data storages.

The data storage 145 may include data, such as provisioning data, pertaining to the endpoint devices 105, intermediate devices 115, and endpoint manager servers 135 and relationships between the endpoint devices 105, intermediate devices 115, and endpoint manager servers 135. For example, the data storage 145 may include a table or list of endpoint devices that are associated with a particular endpoint manager server 135. The data storage 145 may include data pertaining to messages received from endpoint devices, such as a timestamp of the receipt of the message, a timestamp associated with the creation of the message, a sticker ID, a geo-location associated with the message and/or the endpoint device 105 that created or transmitted the message, sensor data associated with the endpoint device, routing information for how and/or where to send data between endpoint manager servers 135 and endpoint devices 105, connection strengths between intermediate devices and endpoint devices, proximity of an endpoint device 105 to an intermediate device 115, type of wireless network 110 that connects an intermediate device 115 and an endpoint device 105, a cost of a connection between an intermediate device 115 and an endpoint device 105, a current battery level of the intermediate device, a type of intermediate device, provisioning requests, provisioning details, past provisioning data, current provisioning data, etc.

The message manager 140 may process communications between the endpoint devices 105, the intermediate devices 115 and the endpoint manager server(s) 135. In an example, the message manager 140 may receive a message from the first intermediate device 115a via the second network 120a. The message may have been sent to the intermediate device via the first short-range wireless network 110a by first endpoint device 105a. A message may contain provisioning characteristics about the endpoint device 105, including an identifier of the endpoint device 105 (e.g., a MAC address, a unique ID), a sticker ID, a geographical location of the first endpoint device 105a, and advertisements of the UUIDs of the services it supports, etc. The message manager 140 may identify the provisioning characteristic of the message, such as by analyzing the message to identify information pertaining to the message.

The message manager 140 may access the data storage 145 to identify, based on the provisioning characteristic of the message, further provisioning data for the endpoint device 105. Such further provisioning data may include an identification of an endpoint manager server 135 that is associated with the message. The data storage 145a, 145b can include data from the manufacturer cloud 205 and PKI blockchain node 209 discussed below. For example, the identifier of the endpoint device may be associated with a particular manufacturer that operations a particular endpoint manager server 135. The message manager 140 may identify this particular endpoint manager server 135 in the data storage 145 and an address and/or path to send the message in order to reach the endpoint manager server 135. In at least some embodiments, the message manager 140 may send the message, or a beacon message to the endpoint manager server 135 via the third network 130. The beacon message may include a beacon, may not include the beacon, or may include information pertaining to the beacon.

In at least one embodiment, a message may include data from multiple services associated with the endpoint device 105. Additionally or alternatively, multiple message from a single endpoint device 105 may be generated and broadcast via the wireless network 110. Each of these multiple messages, for example, may be associated with a different service associated with the endpoint device 105. The message manager 140 may identify the services, and based on information for the service, identify an appropriate endpoint manager server 135 that should receive a message.

The endpoint manager server 135 may receive the message from the relay server 125. The endpoint manager server 135 may store the message, process the message, generate a report based on the message, may generate a notification or response based on the message, or any other action. For example, endpoint manager server 135 may generate a response message pertaining to the message. The response message may include a message intended for one or more of the relay server 125, an intermediate device 115, the endpoint device 105 that generated the message, or another endpoint device 105 that did not generate the message. The endpoint manager server 135 may send the response message to the same relay server 125 that sent the message to the endpoint manager server 135 (e.g., the relay server 125a), or to a different relay server 125 that did not send the message to the endpoint manager server 135 (e.g., relay server 125b).

The relay server 125 may receive, from the endpoint manager server 135, the response message pertaining to the message. The relay server 125 may process the response message, such as by performing operations at the relay server 125, sending data to another device (e.g., a user device), sending data to an endpoint device 105, etc.

The network architecture 100 may be used to exchange data between any devices capable of network-based communication in a manner that is different than conventional communication over the Internet.

In an example, the network architecture 100 may leverage existing infrastructure to create delay-tolerant connectivity and provisioning. The network architecture 100 can move data to the cloud in an initially delay tolerant fashion, which may be useful for many types of IoT communications such as provisioning, firmware updates, status updates, log-file storage, and micropayments. The intermediate device may include software that runs on devices to periodically scan for other devices (e.g., the endpoint devices 105) like industrial devices, smartwatches, wearables, logistics trackers, and environmental sensors. These endpoint devices 105 may connect with the software client running on the devices to provisioning, and/or to create massive, area wide networks for moving data to and within the cloud.

Modifications, additions, or omissions may be made to the network architecture 100 without departing from the scope of the present disclosure. The present disclosure more generally applies to the network architecture 100 including one or more endpoint devices 105, one or more wireless networks, one or more intermediate devices 115, one or more second networks 120, one or more relay servers 125, one or more third networks 130, and one or more endpoint manager servers 135 or any combination thereof.

Moreover, the separation of various components in the embodiments described herein is not meant to indicate that the separation occurs in all embodiments. In addition, it may be understood with the benefit of this disclosure that the described components may be integrated together in a single component or separated into multiple components.

II. Provisioning Process

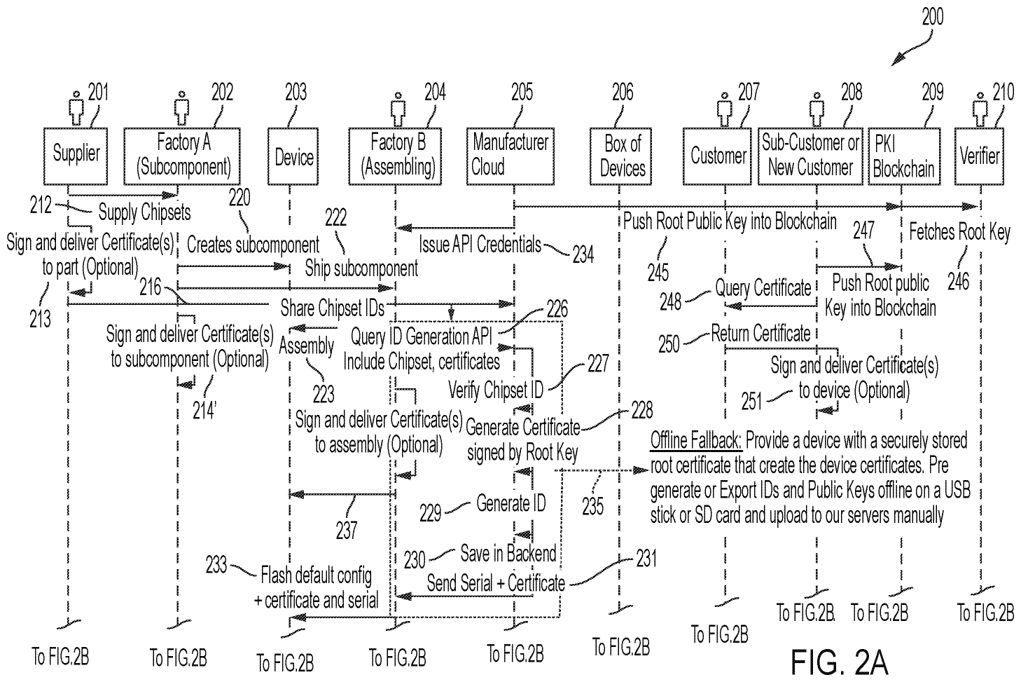

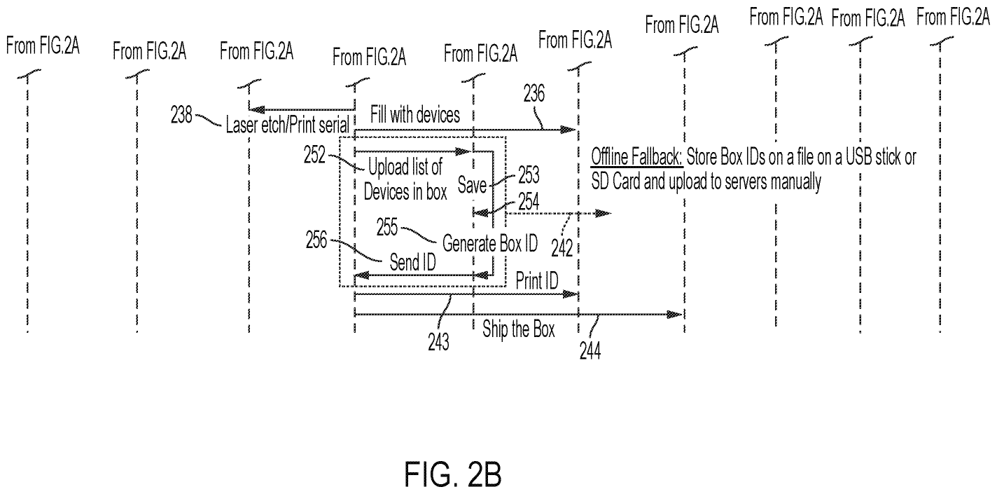

FIGS. 2A-B illustrates a provisioning process sequence diagram 200. The provisioning process can be for any device including any device described herein, including, for example, an endpoint device, intermediate device, server, compute device, sticker, printed device, etc.

The provisioning process operates from a supplier 201 to a verifier 210. The process sequence operates in a network environment as discussed above that benefits from a system of interrelated devices with unique identifiers with the ability to transfer data over a network without requiring human interaction, also referred to as the internet-of-things (IoT).

The sequence may start with the supplier 201. The sequence may also include factory A 202 (e.g., subcomponent manufacturer), device 203, factory B 204 (e.g., assembly manufacturer), manufacturer cloud 205, box of device(s) 206, customer 207, sub-customer or new customer 208, PKI blockchain node 209, and verifier 210. As will be appreciated by those skilled in the art, factory A 202 and factory B 204 can be the same factory without departing from the scope of the disclosure; thus the disclosed process is applicable in a vertically integrated manufacturing process, or a horizontally integrated manufacturing process. Additionally, a manufacturer cloud 205 can be maintained by a third party serving a plurality of manufacturers.

The supplier 201 supplies a part 212. As the supplier 201 supplies the part 212, such as chipsets, the supplier 201 may also sign and deliver one or more certificates 213 for the supplied part. The one or more certificates can be validation certificates for validated subcomponents. The one or more certificate can include device data and form part of a device record. The certificate can be sensed by the network automatically or semi-automatically. The one or more certificate becomes associated with the part and/or the device and can become part of an activity record that tracks a device or device component through the manufacturing process. Factory A 202, as recipient of the supplied part from the supplier 201 can use the part to create a subcomponent 220 for the device 203. The subcomponent can be shipped 222 to factory B 204 for assembly. Additionally, the supplier 201 can share part ID information 216 directly to a manufacturer node 205. Part ID can be, for example, chipset IDs. Factory B 204 assembles device 203 with the parts and subcomponents received. During the assembly process 223, a manufacturer node 205 deploys a Query ID generation API 226. The Query ID Generation API 226 verifies the chipset ID 227, generates a certificate signed by a root key 228, and generates an ID 229 which is saved, such as in a backend 230. The serial and certificate are sent 231 from the manufacturer node 205 to factory B 204. Signed and delivered certificates can also be provided to the device 232. A flash default configuration can be provided with the certificate and serial ID 233 to the device. Additionally, laser etching or printing of serial ID 238 can also be provided from factory B 204 to the device 203. The manufacturer cloud 205 can also issue API credentials 234 to factory B 204. As an offline back-up 235, the device can be provided with a securely stored root certificate that creates the device certificate. Device certificates can be pre-generated or exported for IDs and public keys and can be used offline on, for example, a USB device or an SD card

During the manufacturing process one or more devices can be placed 236 into a box of devices 206; each device can also have its own box or container structure. Additionally, Factory B 204 can upload a list of devices in a box 252, which is saved 253 with a generated box ID 255. The uploaded list can include device components. The list is a list of validated devices and can include validation certificates for each of the validated devices. The generated box ID can then be sent 256 from the manufacturer cloud 205 to factory B 204. The generated box ID can also be stored offline 242, such as on a USB device or SD card. The offline generated box ID can then be uploaded to servers manually. Once the boxes are filled with devices the ID can be printed 243 and then the box 206 is then shipped 244 to a customer 207. The manufacturer cloud 205 can also push a root public key into the blockchain 245 maintained on the PKI blockchain node 209.

The sub-customer 208 can push a root public key into the blockchain 245 at the PKI blockchain node 209. Once the root public key into the blockchain 245, the verifier 210 can fetch the root key 246 from the PKI blockchain node 209. The sub-customer or new customer 208 can also push a root public key into the blockchain 247 at the PKI blockchain node 209. The sub-customer or new customer 208 can query certificates 248 from the customer 207. The customer 207 can return certificates 250 to a sub-customer or new customer 208, and optionally sign and deliver certificates 251.

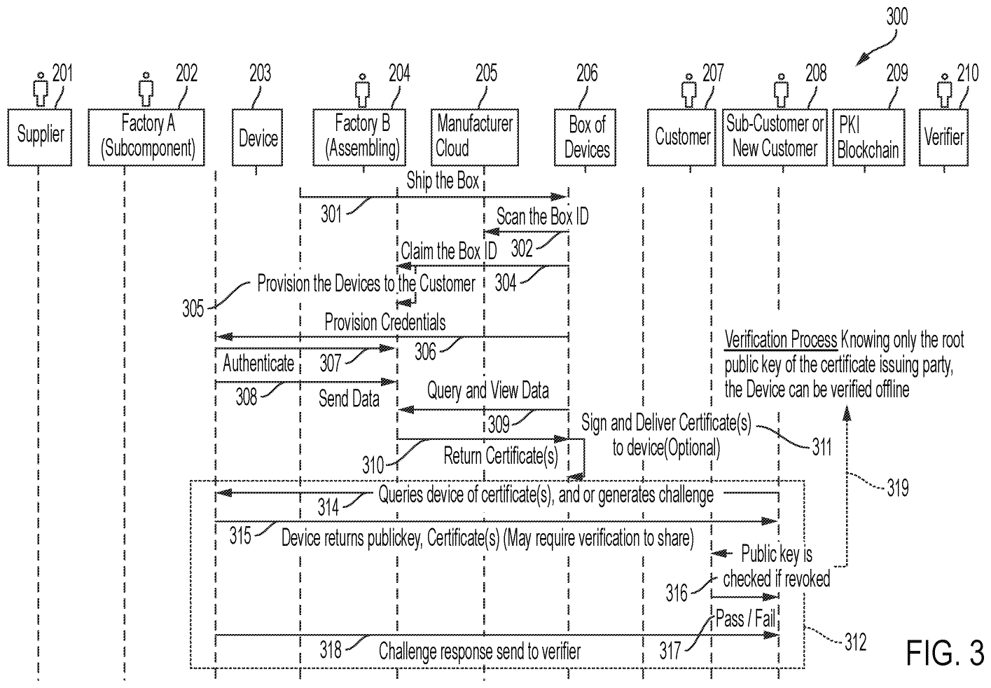

Turning now to FIG. 3, a sequence diagram of a verification process 300 is illustrated. The sequence involves the same or similar entities as described in FIGS. 2A-B. As illustrated in this FIG. 3, the device 203 is shipped in a box 301 from the manufacturer, e.g., factory B 204. The box ID for the box of devices is scanned 302. Factory B claims the box ID 304. At 305 factory B 305 may provide the devices to customer 207. At 306 credentials for the box of devices 206 are provided for the devices 203. Devices 203 can be authenticated 307 by factory B 204, and data for the device 203 can be sent 308. The box of devices data can be queried and viewed 309 by factory B 204, certificates can be returned 310 in response to the query. At 311, certificates for the devices 203 can be delivered and signed. An additional process 312 can be provided which allows a sub-customer to query devices certificates and/or generate a challenge 314, in response to the query for certificates, the device can return a public key and/or certificate 315. In some configurations verification may be required prior to sharing public key and certificate information. At 316, the public key is checked for revocation. At 317, a pass/fail can be provided. A challenge response can be sent from the device 203 to the verifier 318. At 319, it will be appreciated that knowing only the root public key of the certificate issuing party, the device 203 can be verified.

A scanning device (e.g., a phone using a camera, NFC, etc.) can be used to link the device 203 to a server, establishing a peer-to-peer (P2P) connection. Additionally, augmented reality (AR) glasses can also be used to provision a device 203, and a separate phone or base station (e.g., network) can load configuration details and update a server.

At any and all steps of the disclosed processes, the state of the configuration can be tracked and the authenticity verified. If a device does not match a certificate or a certificate has been revoked, the device may cease to operate, self-isolate, self-destruct, go into a specific operating mode, send error reports, notify a given entity, or completely shut down. Each issued certificate may include the signature of the previous signature by the new authenticating party creating a signature chain of manufacturing and verification.

In an example process, Factory A 202 receives components from the components supplier 201. The components may include hardware security modules, secure elements, or unique identifying marks. The components supplier 201 shares the identifying or cryptographic information with the manufacturer cloud 205. Factory B 204 assembles the device from components and flashes/programs the device or subassembly. Factory B 204 may check to ensure the components are authentic or have not been replaced. Factory B 204 may also write into the device, the certificates generated from components and subassemblies, and their suppliers. Factory B 204 may write into the device a certificate created and signed by itself. Factory B 204 may write into the device provisioning information such as serial number, MAC address, and or a certificate created and signed by the manufacturer cloud 205. Factory B 204 may write into the device a certificate created and signed by third parties. Identifying marks are attached to the device, and/or programmed into the radios, or identifying features (for example, scratches, textures, variations) are recorded and uploaded to a computer vision system) A box 206 or group of devices is filled, scanning identifying marks or wireless identifiers as each device 203 is added to the box 206. This may include loading final provisioning information into the hardware as it scanned, such as provisioning information, serial number, shipping provider, tracking number, destination information such as wireless access credentials. A box ID is generated. The box ID may include a single identifier that is linked in a database to the contents of the box. An entire box (or pallet) of devices may be provisioned at once using the box ID. The box ID may include storing multiple identifiers within the identifier (e.g., a QR code listing the contents of the box). In some configurations, the box ID may include using computer vision and variations in the texture of the box to uniquely identify the box. The box 206 or group of devices may include a roll, pallet, crate, shipping container, truck, ship, rocket, vessel, bag, assembly, or any form that may contain multiple devices within or on it. The box or group of devices may include compute capabilities (for example a flexible compute module) that may be loaded with provisioning information and may be used to log, secure or prevent tamper of the goods within.

The box 206 or group of devices is shipped to the provisioner (which may include the manufacturer's customer, the manufacturer, a third party, individual or autonomous system that is deploying or setting up devices. The provisioner can be authenticated with their own cloud, the manufacturer cloud, service provider cloud, or a decentralized system. The provisioner scans the box of devices 206, or the box of devices is marked as arrived by the shipping provider or third party asset tracking provider. A configuration is associated with the devices 203 which may include wireless connectivity credentials, root authority keys, access credentials, and other metadata. Individual provisioning information may be associated with each device 203 at this stage. The devices 203 are removed from their “box” and deployed into an operational environment. The provisioner may use a code scanner, computer vision, a smartphone, or any connected device to individually associate a device to another object, person, entity, or metadata. Configuration information may be associated in a previous step or at a factory. Configuration information may automatically be associated the device 203 using computer vision, pattern recognition neural networks wireless signals, sensors, usage statistics, and other third party data to derive context.

Devices 203 are loaded with the configuration information which may include wireless provisioning details, network settings, certificates generated from components and subassemblies, suppliers, factories, individuals, manufacturers and other parties. Devices 203 may advertise public identifiers wirelessly (or upon a trigger) to await delivery of credentials or information. Devices 203 may also be loaded with configuration information encrypted P2P by the configuror. Devices may be loaded with configuration information by another device using a decentralized wireless networking provider. Devices may be loaded with configuration information by another device that has just been configured nearby. Devices that has been setup may check a non-configured device's certificate or certificate chain, and upon verifying its integrity share encrypted provisioning information. Devices also may be pre-loaded with configuration information, and fetch updated information using internal connectivity. Third parties may verify any certificate or the entire certificate chain stored on the device to verify the integrity, authenticity, and use for access control of the device. Certificates may be stored on the device 203, a centralized system (such as manufacturer cloud 205), or a decentralized system. Controls may be in place requiring the verifier 210 to have permission to verify a device 203 (for example, present its own certificate signed by a specific or same authority) before being able to verify. Scanning a box of devices 206 and provisioning an individual device 203 may take place in any order, combination, or be skipped completely.

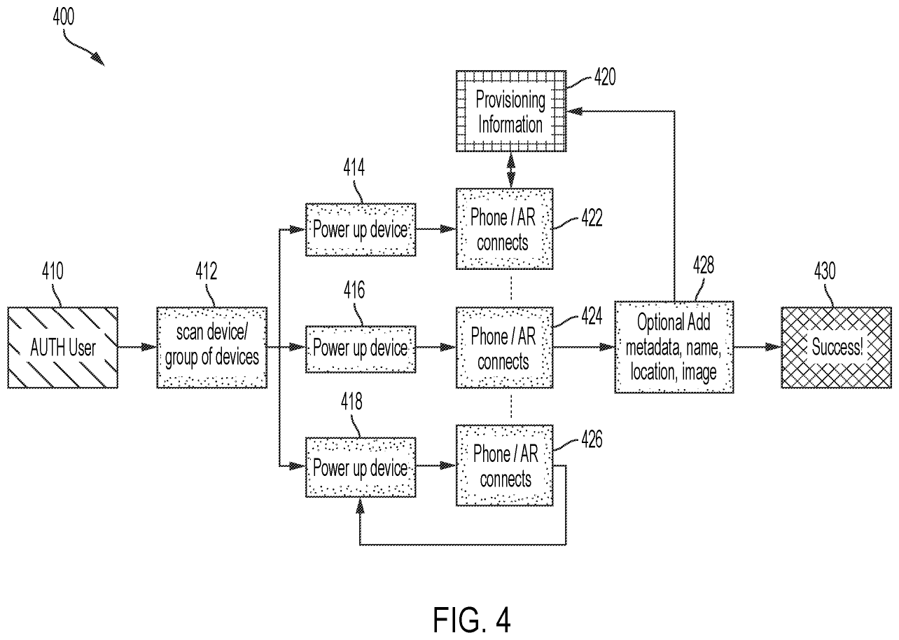

FIG. 4 illustrates a flow diagram of a provisioning process after a factory using an augmented reality app 400. The process begins with authenticating the user 410. Once the user is authenticated 410, the user using wireless or visual identifiers (such as QR code or iChing code) or other computer vision scans the device or a box of devices or wireless identifiers to receive identifiers 412 (in a P2P fashion or from a server). Machine learning may be included to identify the device 203 with a camera without a custom identifier. The identifying information includes: a public key, provisioning information, static identifiers (via radio or near field communication (NFC)). A network, such as the network of FIG. 1, can be used to secure credentials and deliver certificates. A custom uniform resource locator (URL) can be provided to open a webapp, app or URL to set-up. The device(s) are powered up/awakened 414, 416, 418 and connected. Devices can be connected to a cloud, a provisioning device, a separate device (e.g. a smartphone, or AR device) or another provisioned device to share its public key 422, 424, 426. The connection and sharing process may take place in a P2P network or using a separate network. Additionally, the connecting and sharing may leverage wireless, (such as Bluetooth, Wi-Fi, Cellular, NFC) audio, LEDs, lasers, ultrasonic communication for the sharing of identifying and provisioning information. Devices can fetch provisioning information 420 and Wi-Fi, cellular, or RAN details. Sharing of certificates can include, for example, authentication information, set-up information. Additionally, sharing of certificates can occur when connecting a base station to a greater network, connecting a device to a network, provisioning an eSIM, and/or IoT device can present a certificate from factory, manufacturer, chip manufacturer. Metadata such as the device name may be added 428 by the use, or automatically through location, captured wireless signals, and/or AI/machine learning, neural network outputs. The system is configurable to check certificates and then provision new certificates under decentralized system. Additional features such as key exchange, loading certificate, cryptographic challenge response. A visual indicator showing that one or more devices are connected can also be provided. The process of powering up the devices 412, fetching and provisioning information 420 and adding metadata 428 processes can be repeated automatically without user input to bulk provision one or more devices until complete 430.

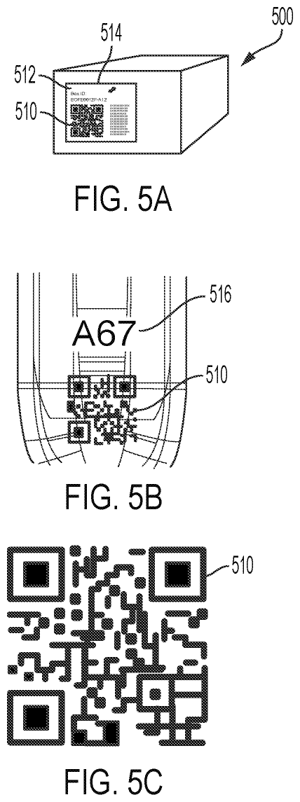

FIG. 5A illustrates a group ID 510 and box ID 512 on a box 500. Additional information 514 can be provided. FIG. 5B illustrates a QR code 510 that encodes a URL with a serial number and provides an easy ID 516. FIG. 5C illustrates a QR code that includes the QR code. The box ID is a readable locator that include an easy ID, for example a serial number and a visual code. The serial number may include the easy ID, e.g., a letter followed by two numbers, or other short nomenclature used to easily identify the component and/or device by users. Eight character hexadecimals can also be used to make it difficult to determine how many units were made or were made in a lot. The hexadecimal provides additional device and lot tracking information for traceability.

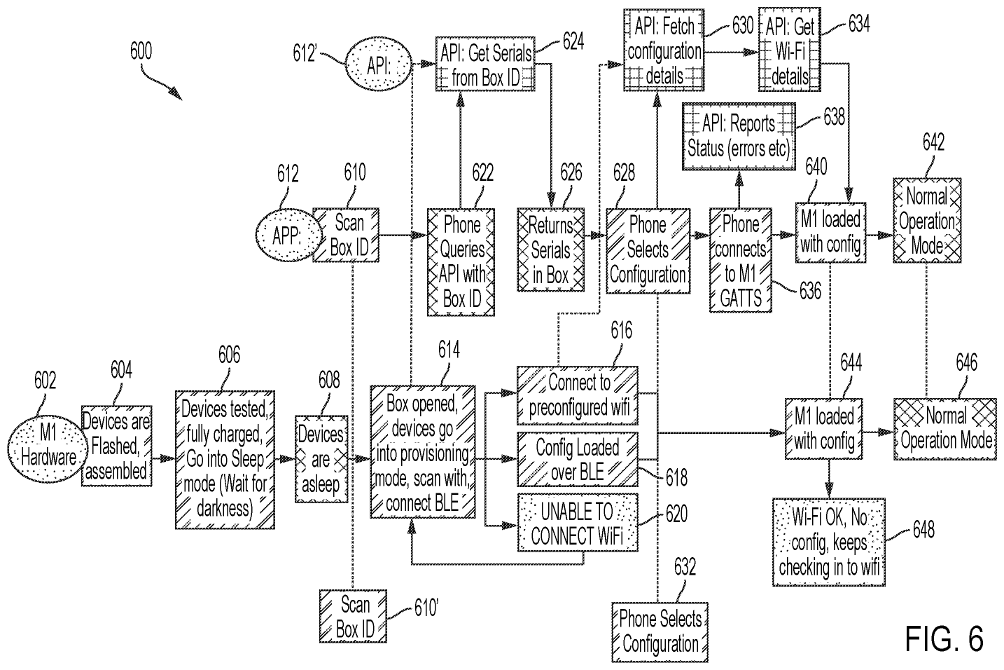

Turning now to FIG. 6, a flow diagram of a factory provisioning process is illustrated. Hardware is provided 602 to one or more devices. The one or more devices are flashed and assembled 604. Once assembled, devices are tested, fully charged, and put into a low power mode 606 (e.g., sleep mode, standby or suspended mode). Once the devices are asleep 608, the devices are placed within a box and processed at a next step. An app 612 can be used to scan a box ID 610, 610′ associated with one or more devices. Once the box ID is scanned 610, the app 612 can communicate with app 612′ to set the serial numbers from the box ID 624, or query the API with the box ID 622 which is then provided at the get serial numbers from the box ID 624. Alternatively, once the box ID is scanned 610, the box can be opened 614 at which point the one or more devices can go into a provisioning mode wherein the devices scan for Wi-Fi and connect via a Bluetooth low energy (BLE) network or other wireless personal area network. Once the API gets the serial numbers from the box ID 624, serial numbers are returned in box 626. Thereafter the device selects a configuration 628. Once the configuration is selected the API fetches configuration details 630 via the network. Once the configuration details are fetched 630, the API gets Wi-Fi details 634, which is then loaded 640. Alternatively, once the device selects a configuration 628, the device can connect to a general attribute profile (GATT) 636, which is then loaded 640. Once the configuration is loaded 640, the device can proceed to normal operation mode 642.

Proceeding from the box opening/provisioning mode 614. The device can connect to a preconfigured Wi-Fi 616, load the configuration over BLE 618, and/or be unable to connect to Wi-Fi 620. Thereafter, the M1 can be loaded with the configuration 644, followed by normal operation 646, or if no configuration is available the device would continue checking with Wi-Fi 648 until a configuration can be loaded. During this process, the device selects its configuration 632. API reports (e.g., status reports, error reports, etc.) can be provided 638.

As will be appreciated by those skilled in the art, the systems and methods provide for secure sharing of credentials. A P2P provisioning of configurations (e.g., metadata and certificates) is also provided. The systems and methods use a decentralized network to load the configurations. The network uses machine-readable instructions that are executable and stored on non-transitory machine-readable medium to operate. Once the configurations are loaded, the entity that “sees” the device and the entity that loads the configuration can be separate entities. For example, a scan of a box with a device (such as a phone) will automatically set-up and the devices inside the box to be set-up with one another automatically. This process can be performed at a factory, e.g., using AI and wireless to determine what is being tagged, provisioning by box, and automatic provisioning to users, AR can also be used.

Configurations can include people/devices to provision, metadata, identifiers, ID tiers, public key (e.g., existing keys or provided keys), wireless authentication, eSIM profile, and/or certificates. Devices can also be attached to “hosts” instead of people. The devices and components can a suitable low power network, and stickers to communicate information. Secrets can be secured in a distributed way, such as by Shamir's Secret Sharing (SSS), to provide secure information and encryption keys. A hardware security module (HSM) can also be used. The HSM provides a physical device that provides extra security for sensitive data and can be used to provision cryptographic keys for critical functions such as encryption, decryption and authentication. The entire process follows a trust on first use (TOFU) principle. The TOFU principles is an authentication scheme that establishes a trust relationship with an unknown or not-yet-known endpoint. The TOFU process uses a look-up feature.

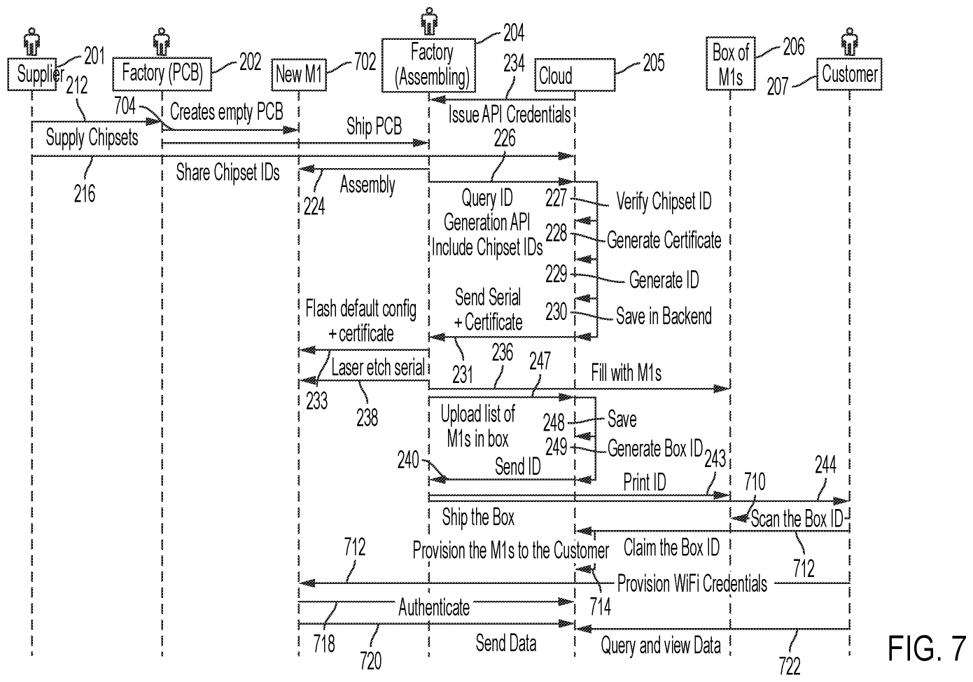

FIG. 7 illustrates a sequence diagram of a factory production process. The factory production process includes the similar functions or entities as shown in FIGS. 2A-B. The sequence proceeds from the supplier 201 to the customer 207. The factory 202 can create an empty PCB 704 that is provided to a new low power wide area network device (new M1 702). In an additional step, the customer 207 can scan the box ID 710 and send the scanned box ID to the box of devices 206. The customer 207 can also claim the box ID 712 which is communicated to the cloud 205. Once the customer claims the box ID, the devices are provisioned to the customer 714 in the cloud. The customer 207 also provides Wi-Fi credentials to the new M1 702. Once the Wi-Fi credentials are received, authentication information is sent 718 to the cloud 205, along with additional data 720. The customer 207, can query and view data 722 from the cloud 205.

The process in FIG. 7, allows for generation of a plurality of valid serial numbers/Random Strings. It also allows for printing of a plurality of labels which can then be attached to non-flashed M1 devices. In this process, everything is configurable manually. This includes generating one or more certificate(s), provision a backend for the device by manually using its CLI tool, and manually flashes the M1 with its configuration parameters and certificate.

As will be appreciated by those skilled in the art, the provisioning process works for pre-production serial numbers and box IDs that are pre-provisioned. This process can include a new node or cloud and can use factory credentials to obtain a new easy ID and certificate through the API, factory printing of the Serial number, and easy ID combinations on to the front and back of device, and a flash configuration inside the device which includes a certificate and default configuration. Additionally, shipping can include printing on a box of devices a list of serial numbers associated with devices in the box, uploading a file with the serial numbers onto a server, and printing a box serial number of the device(s). Once the box and/or device arrives at a customer's premises a box full of M1s is provided with provisioning instructions. As discussed above, the box or device is scanned to claim the device.

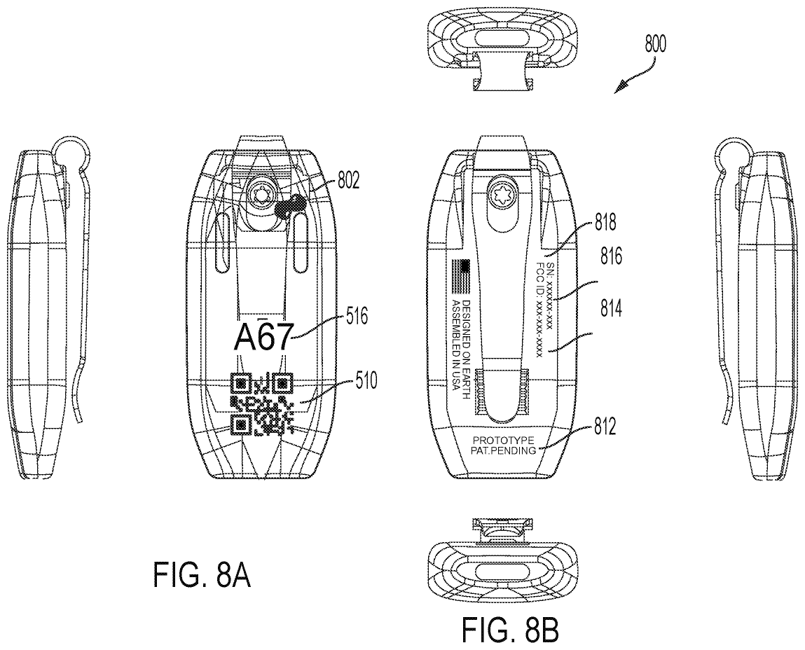

FIGS. 8A-B illustrates example box labels 800 which include a logo 802, and easy ID 516, and a QR code 510 with URL and serial number information encoded in the QR code, which may be used for any item, device, or box or system, including but not limited to the device depicted in the FIGS. 8A-B. Certification logos 818, FCC ID 816, Manufacturer markings 814, and patent information 812 can also be provided.

The techniques, methods, and processes described herein, including for provisioning, manufacturing, and deployment can be used for any device including any device described herein, including, for example, an endpoint device, intermediate device, a server, a compute device, a sticker, a flexible device, a printed device, etc. An example device may include a compute device with an antenna combination that includes at least one primary antenna element operably coupled to at least one other electronic component that services as a ground plane for the at least one primary antenna element. In some embodiments, a compute device can include: a substrate; at least one circuit trace on the substrate that is electronically coupled to electronic components, wherein the electronic components include at least a processor, memory, and transceiver; at least one power source operationally coupled with the electronic components; at least one antenna layer over the substrate that has at least one primary antenna element of at least one antenna assembly, wherein each antenna assembly is operationally coupled with the transceiver as a data communication link, and each primary antenna element is operationally coupled to at least one of the electronic components or power source as a structure of at least one ground plane for the respective primary antenna element; and a coupling member configured for being coupled to an object. In some aspects, the power source is selected from a battery, solar element, or combinations thereof.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “obtaining,” “correlating,” “determining,” “validating,” “receiving,” “generating,” “transforming,” “requesting,” “creating,” “uploading,” “adding,” “presenting,” “removing,” “preventing,” “providing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a computer selectively activated or reconfigured by a computer program stored in the computer. Such a computer program may be stored in a non-transitory computer readable storage medium, such as, but not limited to, any type of disk including floppy disks, optical disks, compact disc read-only memories (CD-ROMs) and magnetic-optical disks, ROMs, RAMs, erasable programmable read-only memories (EPROMs), electrically erasable programmable read-only memories (EEPROMs), magnetic or optical cards, flash memory, or any type of media suitable for storing electronic instructions.

The words “example” or “exemplary” are used herein to mean serving as an example, instance, or illustration. Any aspect or design described herein as “example' or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A method comprising:
receiving subcomponent data associated with a subcomponent;
receiving the subcomponent;
incorporating the subcomponent in a device;
receiving device data associated the device;
appending the subcomponent data to the device data;
validating at least one of the subcomponent and the device based on one or more of the received subcomponent data and the received device data;
creating an activity record of at least one of the validated subcomponent and validated device;
appending the validated activity to a device record; and
providing the device record.

2. The method of claim 1 further comprising digitally signing one or more validation certificates for one or more of the device and the subcomponent.

3. The method of claim 2 further comprising digitally delivering one or more validation certificates for one or more of the device and the subcomponent.

4. The method of claim 1 further comprising storing the device record.

5. The method of claim 4 further comprising storing the device record a removable media.

6. The method of claim 1 further comprising pushing a root public key into a blockchain.

7. The method of claim 6 further comprising fetching a root key from the blockchain.

8. The method of claim 1 further comprising powering one or more devices in proximity and providing provisioning information.

9. The method of claim 1 further comprising associating a readable locator with the device.

10. A non-transitory machine-readable medium comprising a plurality of machine-readable instructions, the machine-readable instructions executable to perform operations comprising:
receive subcomponent data associated with a subcomponent incorporated into a device;
receive device data associated the device;
append the subcomponent data to the device data;
validate at least one of the subcomponent and the device based on one or more of the received subcomponent data and device data;
create and store a record of at least one of the validated subcomponent and validated device;
append a validated activity record to a device record; and
provide the device record.

11. The non-transitory machine-readable medium of claim 10 further comprising digitally sign one or more validation certificates for one or more of the device and the subcomponent.

12. The non-transitory machine-readable medium of claim 11 further comprising digitally deliver one or more validation certificates for one or more of the device and the subcomponent.

13. The non-transitory machine-readable medium of claim 10 further comprising store the device record.

14. The non-transitory machine-readable medium of claim 10 further comprising push a root public key into a blockchain.

15. The non-transitory machine-readable medium of claim 14 further comprising fetch a root key from the blockchain.

16. The non-transitory machine-readable medium of claim 10 further comprising provide provisioning information.

17. The non-transitory machine-readable medium of claim 10 further comprising read a readable locator associated with the device.

18. A system, comprising:
a memory;
and one or more processors operatively coupled to the memory, the one or more processors being configured to execute operations to cause the system to perform operations comprising:
receive subcomponent data associated with a subcomponent incorporated into a device;
receive device data associated the device;
append the subcomponent data to the device data;
validate at least one of the subcomponent and the device based on one or more of the received subcomponent data and device data;
create and store a record of at least one of the validated subcomponent and validated device;
append a validated activity record to a device record; and
provide the device record.

19. The system of claim 18 further comprising digitally sign one or more validation certificates for one or more of the device and the subcomponent.

20. The system of claim 19 further comprising digitally deliver one or more validation certificates for one or more of the device and the subcomponent.

21. The system of claim 18 further comprising store the device record.

22. The system of claim 18 further comprising push a root public key into a blockchain.

23. The system of claim 22 further comprising fetch a root key from the blockchain.

24. The system of claim 18 further comprising provide provisioning information.

25. The system of claim 18 further comprising read a readable locator associated with the device.
